(19) United States
(12) Patent Application Publication
(10) Pub. No.: US 2018/0074872 A1
(43) Pub. Date: Mar. 15, 2018

(54) METHOD AND SYSTEM FOR ACCOMPLISHING TASKS ASSOCIATED WITH APPLICATIONS IN AN ELECTRONIC DEVICE

(71) Applicant: Altimetrik Corp., Southfield, MI (US)

(72) Inventors: Aswath Premaradj, Bangalore (IN); Sriraman Raghunathan, Bangalore (IN)

(73) Assignee: Altimetrik Corp., Southfield, MI (US)

(21) Appl. No.: 15/730,019

(22) Filed: Oct. 11, 2017

(51) Int. Cl. G06F 9/54; G06F 9/48

(52) U.S. Cl. CPC G06F 9/543; G06F 9/4881; G06F 9/546

(57) ABSTRACT

The embodiments herein provide a method and a system for accomplishing tasks associated with applications in an electronic device. The method includes receiving one or more task completion requests from one or more primary applications. The one or more task completion requests are associated with at least one of a task id and a parameter id. Further, the method includes determining one or more secondary applications registered to accomplish the one or more task completion requests. Further, the method includes invoking the one or more secondary applications to accomplish the received one or more task completion requests from the one or more primary applications. The method further includes sending an acknowledgement from the one or more secondary applications to the one or more primary applications to indicate a status of the one or more task completion requests.

### TECHNICAL FIELD

The embodiments herein relate to electronic devices and, more particularly to methods and systems for accomplishing tasks associated with applications in an electronic device.

### BACKGROUND

There are a myriad of applications (hereinafter referred to as apps) that a user uses that focuses on some particular aspect of a transaction, example booking a flight, a hotel or a cab. But often the user does a task that comprises of several transactions in a particular order. These apps are often either built to be used in silos or to be used with pre-integrated apps that can be used to complete the transactions. When the apps are in silos, the user is forced to re enter the same information again to complete the transaction. For example, the flight arrival journey date mostly would be the same as the hotel check-in date; the flight arrival time would be the time for cab booking, and so on. If the apps are pre-integrated, the user is not given an option of which app he wants to use next to complete the transaction. Thus, the user is forced to use the pre-integrated apps. For example, if the user is using a flight booking application, which has, been pre-integrated with a cab-booking application. If the user wants to use another cab booking application, the user once again has to enter the details.

### BRIEF DESCRIPTION OF THE FIGURES

The embodiments disclosed herein will be better understood from the following detailed description with reference to the drawings, in which:

FIG. 1 is an example illustration of a subset of an application(s) ontology considering for flight booking, hotel booking and cab booking, according to embodiments as disclosed herein;

FIG. 2 is a block diagram illustrating various unit of an electronic device, according to embodiments as disclosed herein;

FIG. 3 is a flow diagram illustrating a method for accomplishing tasks associated with applications in an electronic device 200, according to embodiments as disclosed herein;

FIG. 4 is a flow diagram illustrating an example flow of parameters between application(s), according to embodiments as disclosed herein;

FIG. 5 is an example flow diagram illustrating mapping parameters of an application(s) with parameters of a task that the applications(s) is capable of handling, according to embodiments as disclosed herein;

FIG. 6 is an example illustration of determining one or more secondary application(s) registered to accomplish the one or more task completion request(s), according to embodiments as disclosed herein;

FIG. 7 depicts the flow of logic when an application(s) requests for a task, according to embodiments as disclosed herein; and

FIG. 8 depicts the flow of logic when an application(s) is installed on an electronic device, according to embodiments as disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

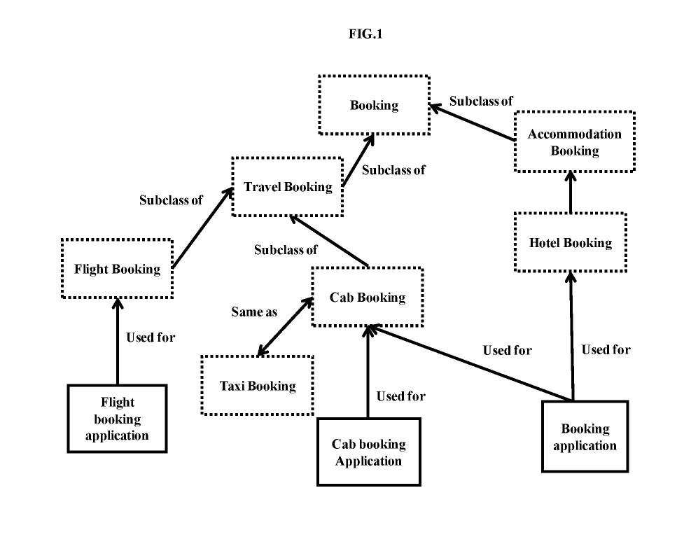

The embodiments herein disclose methods and systems for accomplishing tasks associated with applications in an electronic device. A method includes receiving one or more task completion requests from one or more primary applications. The one or more task completion requests are associated with at least one of a task id and a parameter id. Further, the method includes determining one or more secondary applications registered to accomplish the one or more task completion requests. Further, the method includes invoking the one or more secondary applications to accomplish the received one or more task completion requests from the one or more primary applications. The method further includes sending an acknowledgement from the one or more secondary applications to the one or more primary applications to indicate a status of the one or more task completion requests. Referring now to the drawings, and more particularly to FIGS. 1 through 8, where similar reference characters denote corresponding features consistently throughout the figures, there are shown embodiments.

FIG. 1 is an example illustration of a subset of an application(s) ontology considering flight booking, hotel booking and cab booking, according to embodiments as disclosed herein.

FIG. 1 depicts an example of a subset of an ontology considering flight booking, hotel booking and cab booking. Only a few parameters needed for a transaction are considered for the sake of illustration. A user books for a flight using a flight booking application, which redirects to a hotel-booking task. When the hotel booking task is completed, the flight-booking application then requests for cab booking task. The flight, hotel and cab booking tasks can be categorized under booking class. The booking class can be further classified into travel and hotel booking. The travel booking can be further classified into cab and flight booking. The applications corresponding to flight, hotel and cab booking tasks can be registered as a node of respective classes. In an embodiment, applications can be registered under multiple classes. For example, a booking application can be used for booking hotels as well as booking cabs. Hence, the booking application can be registered under both cab booking and hotel booking classes. In an embodiment, the application ontology can also account for aliases.

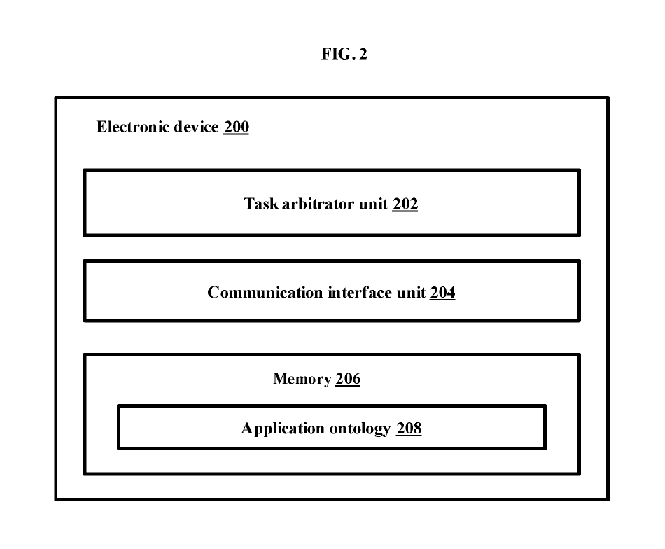

FIG. 2 is a block diagram illustrating various unit of an electronic device 200, according to embodiments as disclosed herein.

In an embodiment, the electronic device 200 can be at least one of but not restricted to a mobile phone, a smartphone, tablet, a phablet, a personal digital assistant (PDA), a laptop, a computer, a wearable computing device, a smart TV, wearable device, a vehicle infotainment system, or any other electronic devices. The electronic device 200 includes a task arbitrator unit 202, communication interface unit 204 and a memory 206. Further, the memory 204 includes application ontology 208. The task arbitrator unit 202 can be configured to receive one or more task completion request from one or more primary applications. The one or more task completion requests can be associated with one or more of a task id and a parameter id. Further, task arbitrator unit 202 can be configured to determine one or more secondary applications registered to accomplish the one or more task completion request. In an embodiment, the one or more secondary applications can be automatically registered to the task(s) during application(s) installation/application(s) update. Further, task arbitrator unit 202 can be configured to invoke the one or more secondary applications to accomplish the received one or more task completion requests from the one or more primary application. In an embodiment, a user input is received by the electronic device 200 to invoke the determined one or more secondary applications to accomplish the received one or more task completion requests from the one or more primary applications. Further, the task arbitrator unit 202 can be configured to send an acknowledgement from the one or more secondary applications to the one or more primary applications to indicate a status of the one or more task completion requests.

The communication interface unit 204 can be configured to establish communication between the electronics device 200 and a network provider to accomplish the one or more task completion requests.

The memory 206 can be configured to store the application ontology 208. The application ontology 208 is the data store that stores the specification of the conceptualization as a graph. The conceptual knowledge of the applications can be generalized and stored in the Ontology Web Language store. The ontology of the applications comprises of the formal definition and description of the applications. The application ontology 208 can also describe the various tasks in each application(s). The tasks in the application(s) can be classified into classes based on the type of task they do. For example, an application(s) may perform a task of booking a cab. The application(s) would be classified under a class “CabBooking”. The classes can be predetermined as part of the application ontology 208 and when there is need for more classes; the classes can be added to the application ontology 208 manually. Each class has a unique id (task id). The instances of the classes can be the application(s). The application(s) can be mapped to a class of tasks they are capable of handling. The application(s) can be mapped to a corresponding class based on information provided by an application developer(s) during application installation(s). The tasks can have inbound and outbound parameters as properties. The inbound/former parameters are required to complete the tasks and the outbound parameters are result of the task(s). Some of the parameters can be defined as classes of their own while others could simply be values. For example, when booking a cab, the type of cab needed, the time in which the cab is required is inbound parameters. The parameters obtained from the result of the booking the cab provide the outbound parameters such as name of the cab driver, registration number of the cab or the like. The inbound parameters can be marked as optional. The inbound and the outbound parameters can be assigned with a unique id. The relationship between parameters of different task(s) can also be defined. For example: the arrival time of a flight can be used to book taxis. Here, the “arrivalTime” is a parameter for a task “FlightBooking” has a “usedFor” relationship with the “cabTime” parameter of the “CabBooking” task. The application(s) and the classes they belong to are stored as nodes. The relationships between the classes are stored as the edges that connect the nodes. The input/inbound and output/outbound parameters are also nodes and the relationship with classes is stored as edges as well. The parameters of the application(s) are mapped to the parameters of its generic parent class.

The memory 206 may include one or more computer-readable storage media. The memory 206 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 206 may, in some examples, be considered a non-transitory storage medium. The term “non-transitory” may indicate that the storage medium is not embodied in a carrier wave or a propagated signal. However, the term “non-transitory” should not be interpreted to mean that the memory 206 is non-movable. In some examples, the memory 206 can be configured to store larger amounts of information than the memory. In certain examples, a non-transitory storage medium may store data that can, over time, change (e.g., in Random Access Memory (RAM) or cache).

The term ‘primary’ and ‘secondary’ referred herein are used for the purpose of labeling. However, the terms can be used interchangeably.

FIG. 2 shows exemplary units of the electronic device 200, but it is to be understood that other embodiments are not limited thereon. In other embodiments, the electronic device 200 may include less or more number of units. Further, the labels or names of the units are used only for illustrative purpose and does not limit the scope of the invention. One or more units can be combined together to perform same or substantially similar function in the electronic device 200.

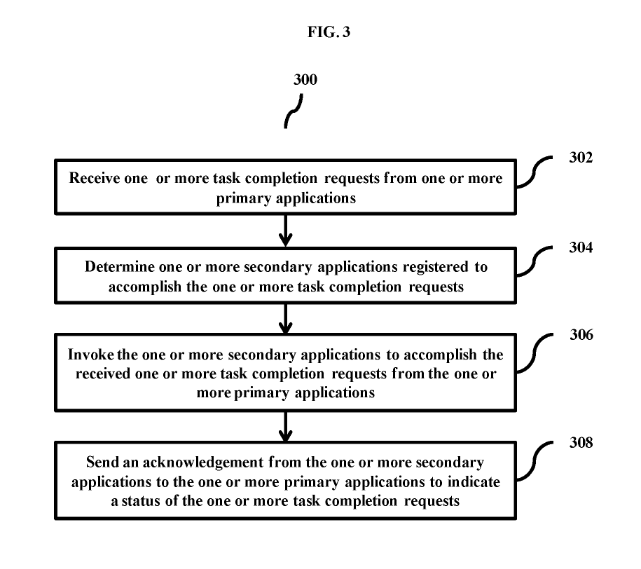

FIG. 3 is a flow diagram illustrating a method for accomplishing tasks associated with applications in an electronic device 200, according to embodiments as disclosed herein.

At step 302, the method includes receiving one or more task completion requests from one or more primary applications. The method allows the task arbitrator unit 202 to receive one or more task completion requests from the one or more primary applications. The one or more task completion requests can be associated with at least one of a task id and a parameter id.

At step 304, the method includes determining one or more secondary applications registered to accomplish the one or more task completion requests. The method allows the task arbitrator unit 202 to determine the one or more secondary applications registered to accomplish the one or more task completion requests. When the electronic device 200 receives a task completion request to complete a task. Then the task goes through the list of registered applications that the task has registered under that task. For example, if the hotel booking application asks for the task, cabbooking, the system gets the list of all apps that are registered under cabbooking.

At step 306, the method includes invoking the one or more secondary applications to accomplish the received one or more task completion requests from the one or more primary application. The method allows the task arbitrator unit 202 to invoke the one or more secondary applications to accomplish the received one or more task completion requests from the one or more primary application.

At step 308, the method includes sending an acknowledgement from the one or more secondary applications to the one or more primary applications to indicate a status of the one or more task completion requests. The method allows the task arbitrator unit 202 to send an acknowledgement from the one or more secondary applications to the one or more primary applications to indicate the status of the one or more task completion requests. The acknowledgement includes at least one of ‘SUCCESS’, ‘FAILURE’ or ‘NULL’.

The various actions, acts, blocks, steps, or the like in the method and the flow diagram 300 may be performed in the order presented, in a different order or simultaneously. Further, in some embodiments, some of the actions, acts, blocks, steps, or the like may be omitted, added, modified, skipped, or the like without departing from the scope of the invention.

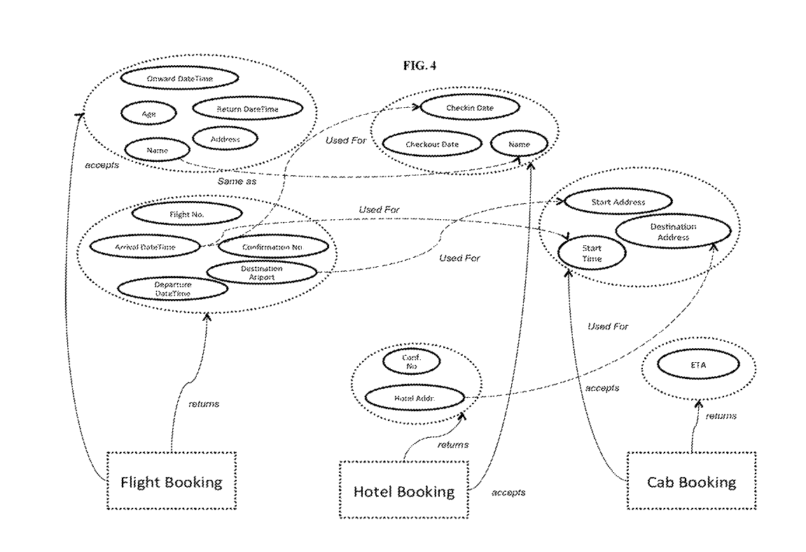

FIG. 4 is a flow diagram illustrating an example flow of parameters between application(s), according to embodiments as disclosed herein.

FIG. 4 depicts flow of parameters between the application(s). The flow diagram depicts the ontological vocabulary in a graphical representation, the graph can be stored any suitable format such as N3 or notation 3, turtle, rdf xml, an OWL specific format and so on. The FIG. 4 depicts the hotel, cab and flight booking tasks as example to illustrate the different parameters it can accept as input parameters and the different parameters it returns as output parameters as a result of performing the task. The FIG. 4 also depicts the relationship between the input and output parameters between tasks (For ex, arrival time in flight booking is used for start time in cab booking).

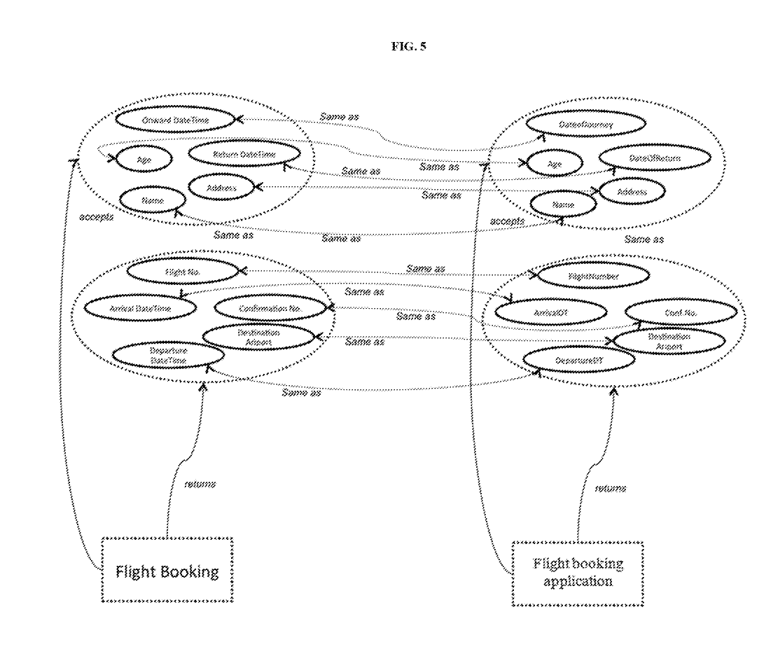

FIG. 5 is an example flow diagram illustrating mapping parameters of an application(s) with parameters of a task that the applications(s) are capable of handling, according to embodiments as disclosed herein. The FIG. 5 depicts the relationship between the classes and their instances (the actual application). The FIG. 5 also illustrates a mapping of the input and output parameters between the class “Flight booking” and a “Flight booking application”. This mapping helps the task arbitrator unit 202 to pass on the parameters when invoking the application.

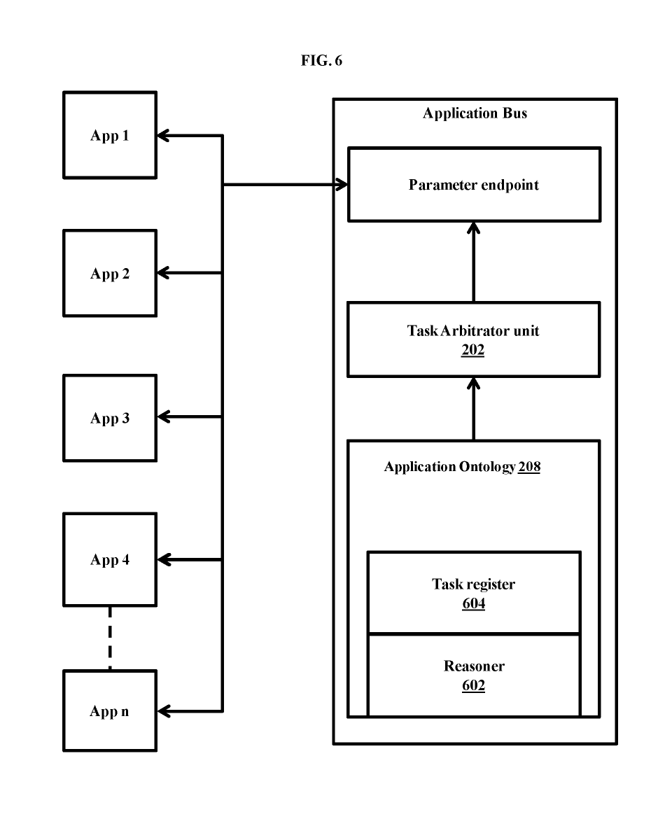

FIG. 6 is an example illustration of determining one or more secondary application(s) registered to accomplish the one or more task completion request(s), according to embodiments as disclosed herein.

The primary application(s) places a task completion request by sending a task id and the parameters id's along with their values to the task arbitrator unit 202. The task id can be the same as class id and the Values act as input parameters. The task arbitrator unit 202 can be configured to identify one or more secondary applications registered for the task(s) based on SPARQL query or any other query language supported by the Ontology Web Language (OWL) specification or the like. The one or more secondary applications can be automatically registered to the task(s) during application(s) installation/application(s) update, if the one or more secondary applications are capable of performing the task(s). The application(s) and the type of supported work can be maintained in the task register 604. The task register 604 also stores the necessary application ontology of the task(s) along with inbound and outbound parameters, if the necessary ontology for the application is not available in the application ontology 208. While storing the ontological information for the application(s), a reasoner 602 can validate the new task information for consistency. If the task arbitrator unit 202 can be configured to determine the one or more secondary application, which is capable of performing the task(s), then the task arbitrator unit 202 can be configured to invoke the one or more secondary application(s) based on the parameters after getting authorization from the user. If the task arbitrator unit 202 identifies more than one secondary application(s) registered for the task, the task arbitrator unit 202 can be configured to provide a notification (such as a popup, widget, and so on) to the user to select the application of his choice to accomplish the task. When the task(s) is completed, an acknowledgement is sent to the primary application(s) with the outbound values returned by the called out task completion request(s). The acknowledgement sent by the secondary application(s) comprises of one of the following—‘SUCCESS’, ‘FAILURE’ or ‘NULL’ (could not find application for task). There can also be nested tasks. For example, Application ‘A’ can request for task ‘X’, done by application ‘B’. Task ‘X’ in application ‘B’ could in turn request for task ‘Y’ which may be done by application ‘C’. In this case, the task arbitrator invokes application ‘B’ to run task ‘X’, sending parameters passed by application ‘A’. When task ‘X’ in application ‘B’ requests for task ‘Y’ as part of running task ‘X’, the task arbitrator invokes application ‘C’ to run task ‘Y’ passing parameters from application ‘B’. When the task ‘Y’ is completed, the task arbitrator sends acknowledgement of the task to application ‘B’ along with the outbound parameter values of the task ‘Y’ as results. When application ‘B’ completes the task ‘X’, the task ‘X’ outbound parameters are sent as results along with the acknowledgement to application ‘A’. This would be a standard process that any system follows and varies from system to system as data is interchanged between the application(s).

The task id can be an optional parameter sent by the primary/calling application(s). For example, if the task id is not sent by the primary application(s), then the task arbitrator unit 202 can be configured to analyze the parameters of the primary application(s) and looks for a direct relationship with the inbound parameters of other task(s). For example, if all of the defined parameters have a match with the all of the inbound parameters of a particular task except the optional parameters, then that task is invoked. If multiple tasks are matched, then the user is given an option to choose. If no direct relation is found between parameters of the primary application(s) and the parameters for the task in the application ontology 208, then the task arbitrator unit 202 can be configured to use an OWL ontology reasoner 602 to find a matching parameter.

For example, if the task id is not sent but the list of input parameters match that of a “cabbooking” tasks input parameter's list (“starttime”, “origin”, “destination”, “typeofcar”<ex: suv, sedan, premium, etc.>), then that task (“cabbooking”) is discerned as the intended task and is carried out. If all of the parameters defined have a match with the all of the inbound parameters of a particular task except the optional parameters, then that task is invoked. If multiple tasks are matched, then the user is given an option to choose. If no direct relation is found between parameters of the primary application(s) and the parameters for the task in the ontology, then the task arbitrator unit 202 can be configured to uses the OWL ontology reasoned 602 to find a matching parameter. For example, in the cab booking scenario, if no application is registered to perform the cab booking task, the task arbitrator unit 202 can be configured to determine the next closest task it can perform using the same set of input parameters. Examples of the input parameters here as sent by the invoking/primary application(s) can be “starttime”, “startaddress”, “destinationaddress”, and so on. For example, an application that can book trains and takes a “departuretime”, “origincity” and “destinationcity”. However, the parameters may not match exactly but the parameters are semantically equivalent or related, that can be identified through the ontology stored. The ontology has the relationships between multiple tasks, parameters. This relationship can be used to determine that the tasks are similar (for example, cabbooking and trainbooking belong to the same super class booking, “starttime” and “departuretime” belong to the same super class of time or the like) and can be suggested to the user.

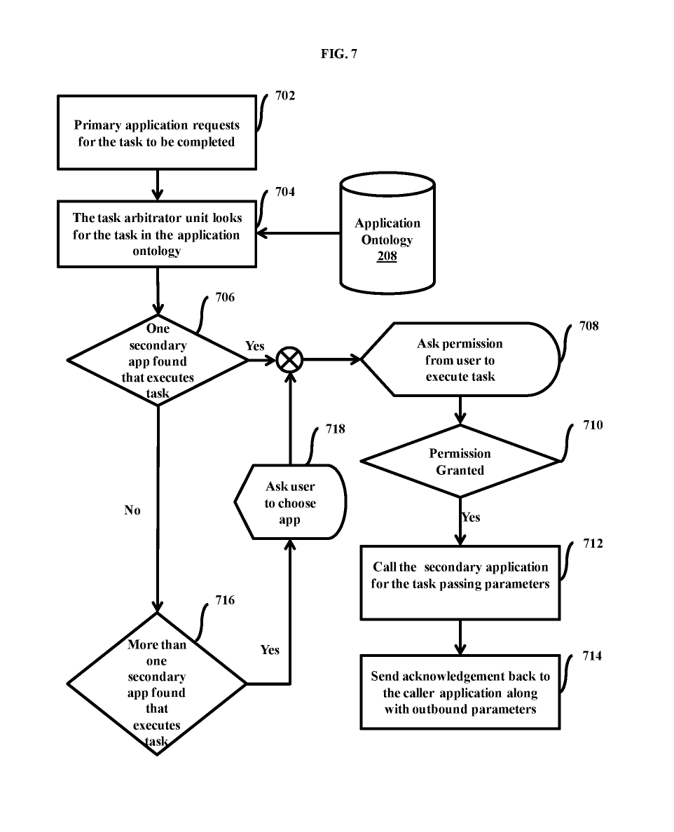

FIG. 7 depicts the flow of logic when an application(s) requests for a task, according to embodiments as disclosed herein.

Initially, the application(s) requests for the task to be completed and the parameters associated with it

The application(s) initiates (702) a task completion request by sending a task id and the parameters id's along with their values to the task arbitrator unit (202). The task id is same as class id and the values acts as input parameters. The task arbitrator unit 202 can be configured to identify (704) one or more application(s) registered for the task(s) in the application ontology 208 based on SPARQL query or any other query language supported by the Ontology Web Language (OWL) specification or the like. The one or more secondary applications can be automatically registered to the task(s) during application(s) installation, if the one or more secondary applications are capable performing the corresponding task(s). If the task arbitrator unit 202 determines (706) a secondary application which is capable of performing/executing the task(s), then the task arbitrator unit 202 can be configured to request (708) for user authorization for task execution. On receiving (710) the user authorization, the task arbitrator unit 202 can be configured to invoke (712) the secondary application for the task completion request to accomplish the task. Further, the task arbitrator unit 202 can be configured to send acknowledgement back to the primary application along with outbound parameters. At step 716, if the task arbitrator unit 202 determines more than one secondary application is registered for the task completion request initiated by the primary application; the task arbitrator unit 202 can be configured to provide a popup to the user to select (718) the application of his choice to accomplish the task. When the task(s) is completed, an acknowledgement is sent to the primary application(s) with the outbound values returned by the called out task completion request(s). The acknowledgement sent by the secondary application(s) consists of one of the following—‘SUCCESS’, ‘FAILURE’ or ‘NULL’ (could not find application for task).

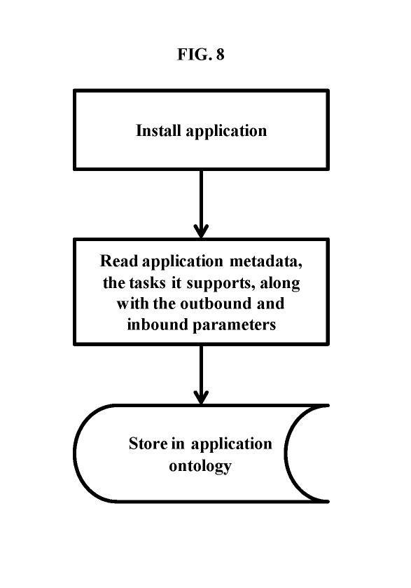

FIG. 8 depicts the flow of logic when an application(s) is installed on the electronic device 200, according to embodiments as disclosed herein.

When the application is installed in the electronic device 200. The application(s) itself registers with a leaf node of one or many task classes based on application metadata, and the type of tasks that application supports. The application and the type of the work it supports can be maintained in the task register 604. The task register 604 also stores the necessary application ontology of the task(s) along with inbound and outbound parameters, if the necessary ontology for the application is not available in the application ontology 208. While storing the ontological information for the application(s), a reasoner 602 can validate the new task information for consistency. The Embodiments herein can invoke one application from another application without having to specifically know about an application programming interface (API) of the invoked application.

The embodiments disclosed herein can be implemented through at least one software program running on at least one hardware device and performing network management functions to control the network elements. The network elements shown in FIG. 6 include blocks, which can be at least one of a hardware device, or a combination of hardware device and software module.

The embodiment disclosed herein specifies a system and a method for accomplishing tasks associated with applications in an electronic device. The mechanism allows invoking an application(s) to accomplish the task requests received from another application. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g. Very high speed integrated circuit Hardware Description Language (VHDL) another programming language, or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. The device may also include only software means. Alternatively, the invention may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments herein can be practiced with modification within the spirit and scope of the claims as described herein.

We claim:

1. A method for accomplishing tasks associated with applications in an electronic device, the method comprising:
receiving, by the electronic device, at least one task completion request from at least one primary application, wherein the at least one task completion request is associated with at least one of a task id and a parameter id;
determining, by the electronic device, at least one secondary application registered to accomplish the at least one task completion request; and
invoking, by the electronic device, the at least one secondary application to accomplish the received at least one task completion request from the at least one primary application.

2. The method of claim 1, wherein the method further comprises sending an acknowledgement from the at least one secondary application to the at least one primary application to indicate a status of the at least one task completion request.

3. The method of claim 1, wherein the at least one secondary application is registered with the at least one task completion request during installation.

4. The method of claim 1, wherein a user input is received by the electronic device to invoke the determined at least one secondary application to accomplish the received at least one task completion request from the at least one primary application.

5. An electronic device comprising a task arbitrator unit configured to:
receive at least one task completion request from at least one application, wherein the at least one task completion request is associated with at least one of a task id and a parameter id;
determine at least one other application registered to accomplish the at least one task completion request; and
invoke the at least one other application to accomplish the received at least one task completion request from at least one primary application.

6. The electronic device of claim 5, wherein the electronic device is further configured to send an acknowledgement from the at least one other application to the at least one application to indicate a status of the at least one task completion request.

7. The electronic device of claim 5, wherein the at least one other application is registered with the at least one task completion request during installation.

8. The electronic device of claim 5, wherein a user input is received by the electronic device to invoke the determined at least one secondary application to accomplish the received at least one task completion request from the at least one primary application.
